(19) United States
(12) Patent Application Publication
(10) Pub. No.: US 2010/0053942 A1
(43) Pub. Date: Mar. 4, 2010

(54) LANTERN WITH MOOD LIGHT AND ROTATING COLLAR DIMMER SWITCH

(75) Inventors: Kevin J. Tarter, Wichita, KS (US); Darin M. Webb, Wichita, KS (US)

Correspondence Address: The Coleman Company, 3600 North Hydraullic, IP Legal- 11702, WICHITA, KS, 67219, US

(73) Assignee: THE COLEMAN COMPANY, INC., Wichita, KS (US)

(21) Appl. No.: 12/300,611

(22) PCT Filed: May 10, 2007
(86) PCT No.: PCT/US07/68687

§ 371 Date: Sep. 12, 2009

Related U.S. Application Data
(60) Provisional application No. 60/747,145, filed on May 12, 2006.

(51) Int. Cl. F21V 15/00

(52) U.S. Cl. 362/182; 315/362

(57) ABSTRACT

A lantern (20) having a rotating collar that serves the function of a dimmer switch (40) for a lamp (32) for the lantern. A mood light (60) may be mounted on the lantern (20). In an embodiment, the mood light (60) is mounted at the top of a cap (28) for the lantern (20).

### REFERENCE TO RELATED APPLICATION

This patent application claims the benefit of PCT Application No. PCT/US07/68687, filed May 10, 2007, and incorporated herein in its entirety and U.S. Provisional Patent Application No. 60/747,145, filed May 12, 2006, and incorporated herein in its entirety.

### TECHNICAL FIELD OF THE INVENTION

The present invention relates to lights, and more specifically to lanterns.

### BACKGROUND OF THE INVENTION

In general, a lantern is a portable light having a fuel source or a power source. The lamp or mantles for a lantern are typically housed behind a round globe, and a base is positioned below the globe and a cap above the globe. Lanterns may be used, for example, for camping, for other outdoor recreational activities, or to provide a work light in an outdoor environment.

Lanterns that burn liquid fuel or low pressure (LP) fuel are well known. More recently, lanterns that operate on batteries have become popular. For example, a lantern may utilize a rechargeable battery or one or more dry cell batteries, such as four D cell batteries. These battery-powered lanterns typically use a light source such as an incandescent bulb, a light emitting diode (LED), a fluorescent tube, or other types of lamps.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description of some embodiments that are presented later.

In accordance with an embodiment, a lantern is provided having a rotating collar that serves the function of turning the lamp on and off and/or serves as a dimmer switch for the lantern.

In accordance with another embodiment, a lantern is provided having a mood light mounted on the lantern. In an embodiment, the mood light is mounted at the top of a cap for the lantern.

In an embodiment, the mood light is removable from the lantern and may be carried, separate from the lantern, by a user. The mood light may include, for example, an attachment for a belt clip, permitting a belt clip to be added and then hung on an article of clothing on a user. As another example, the mood light may include a structure for attachment of a lanyard. A well may be provided on the lantern for storing of the belt clip and/or the lanyard.

In accordance with an embodiment, the mood light includes multiple lamps, each of which is a different color. The different colors may be, for example, red, green, and blue. The colors may be provided by a single light emitting diode (LED), multiple LED's, different lamps, or a colored lens over the light source. To provide a mood effect, the current to the different LED's is regulated so that the color pattern changes over time.

In accordance with an embodiment, a recess is provided on the base of an electric lantern. The recess is configured to receive and store a remote control for the lantern. A clip or other attachment structure may be provided for holding the remote control in place.

Other features of the invention will become apparent from the following detailed description when taken in conjunction with the drawings, in which:

### BRIEF DESCRIPTION OF THE DRAWINGS

FIG. 1 is a side perspective view of a lantern in accordance with an embodiment;

FIG. 2 is a circuit that may be used with a rotating collar dimmer switch of the lantern of FIG. 1 in accordance with an embodiment;

FIG. 3 is a top, side perspective view of the lantern of FIG. 1, with a mood light removed;

FIG. 4 is a back, side perspective view of the mood light for the lantern of FIG. 1;

FIG. 5 is a front side perspective view of the mood light of FIG. 4, with the mood light connected to a lanyard;

FIG. 6 is a circuit for the mood light of FIG. 4 in accordance with an embodiment; and

FIG. 7 is a bottom perspective view of a lantern showing a recess for receiving a remote control in accordance with an embodiment.

### DETAILED DESCRIPTION

in the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Referring now to the drawings, in which like reference numerals represent like parts throughout the several views, FIG. 1 shows a lantern 20 in accordance with an embodiment. The lantern includes a base 22 and a globe 24. A cap 28 is attached on top of the globe 24. A handle 30 is attached to the cap 28 for easy carrying of the lantern 20.

In an embodiment, the lantern 20 is an electric lantern, for example utilizing a battery. However, embodiments described herein may be utilized with a fuel burning lantern.

For the electric lantern 20 shown in the drawings, a lamp 32 is mounted within the globe 24. The lamp 32 may be, for example, an incandescent light, a fluorescent light, or one or more LED lights.

In accordance with an embodiment, the lantern 20 includes a rotating collar dimmer switch 40. The rotating collar dimmer switch 40 is rotatable about the lantern 20. In the embodiment shown in the drawings, the rotating collar dimmer switch 40 is positioned just below the globe 24, at the top of the base 22, but the rotating collar dimmer switch may be located in a different position on the lantern. For example, if desired, the rotating collar dimmer switch could be located above the globe 24 in the area of the cap 28, or at a lower portion of the base 22. In addition, the rotating collar dimmer switch 40 may be positioned somewhere along the height of the globe 24, but positioning the rotating collar dimmer switch in such a place might block part of the light provided by the lamp 32.

In the embodiment shown in the drawings, the rotating collar dimmer switch 40 includes a protrusion 42 that a ds a user in rotating the rotating collar dimmer switch. Alternatively, the rotating collar dimmer switch 40 may include an outer knurled surface, or another suitable gripping contour. In accordance with an embodiment, rotating the rotating collar dimmer switch 40 both turns on and provides a dimming function for the lamp 32. In an alternate embodiment, the rotating collar dimmer switch 40 may provide only a dimming function, and the lamp 32 may be turned on by a separate power control, such as a power button or switch (not shown, but known).

In an embodiment, the base 22 includes indicia to show the current function of the rotating collar switch 40. In the embodiment shown in the drawing, the base 22 includes an “off” indicator 46, shown as a circle to indicate that the lamp 32 is off when the protrusion 42 is aligned with the indicator. In addition, an “on/” indicator 48, in the form of a filled circle, is provided for indicating that the lantern is on, and a dimmer bar 50, in the form of an elongate triangle, is provided on the base 22 for indicating the direction of dimming of the rotating collar dimmer switch 40.

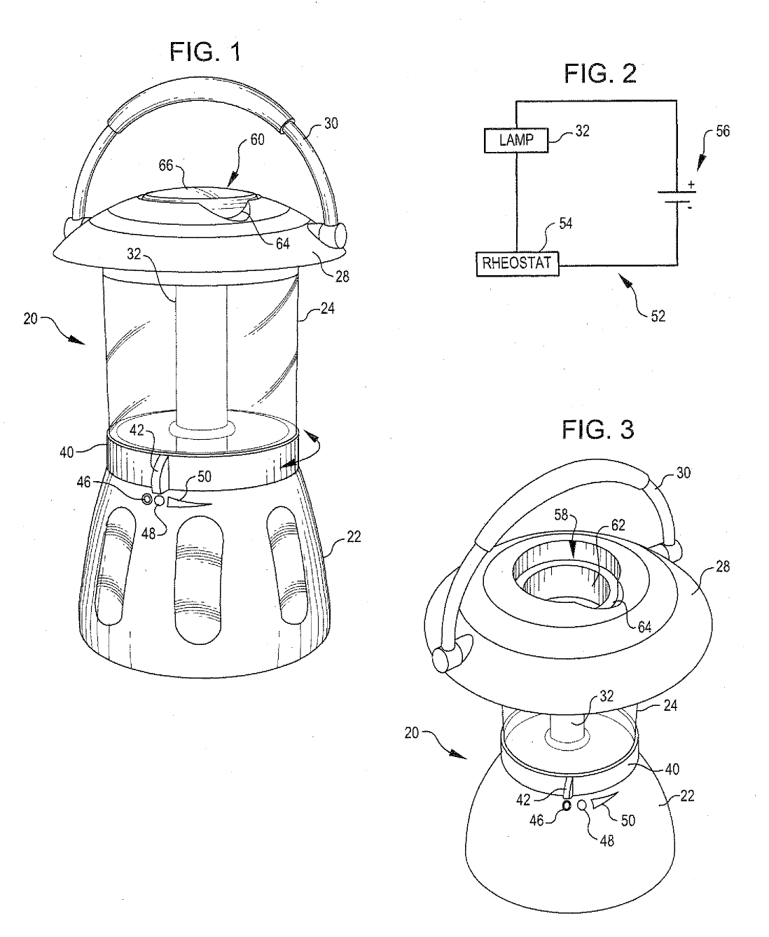

A circuit 52 that may be utilized with the rotating collar dimmer switch 40 is shown in FIG. 2. The circuit 52 includes a dimmer mechanism, such as a rheostat 54, that is activated via the rotating collar dimmer switch 40. The rheostat 54 controls the current supplied to the lamp 32 based upon the amount of rotation of the rotating collar dimmer switch 40. Batteries 56, such as dry cell batteries or a rechargeable battery, are provided. These batteries may be mounted, for example, in the base 22.

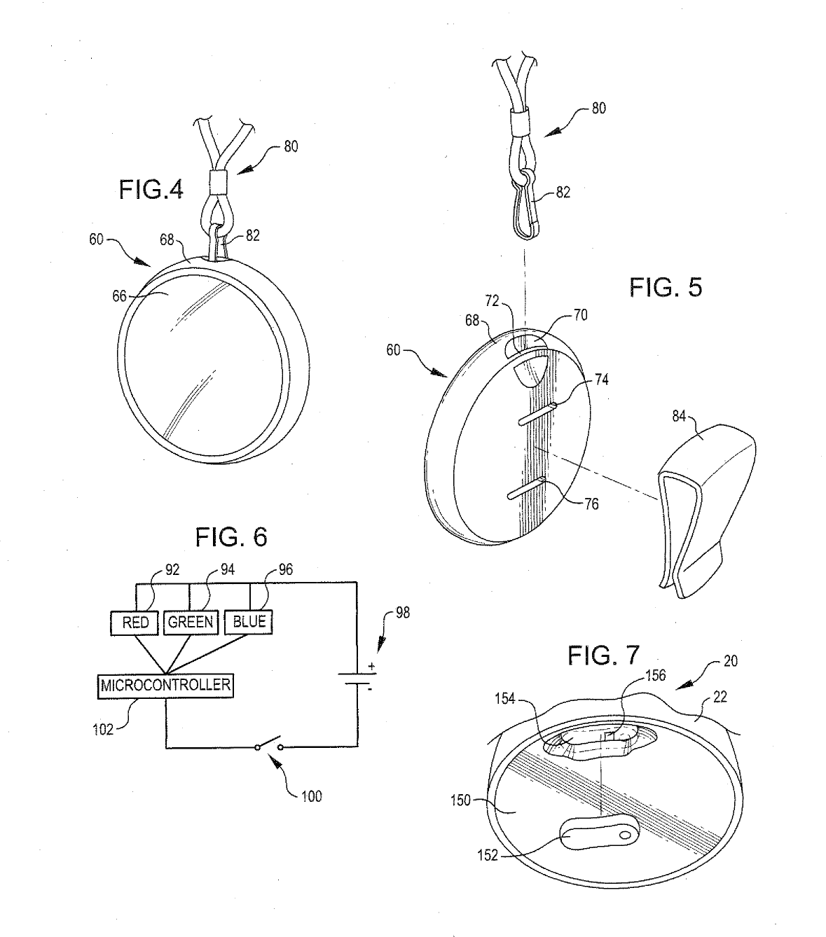

In accordance with an embodiment, the cap 28 includes an indentation 58 (FIG. 3) for receiving a mood light 60 (e.g., FIG. 4). The indentation 58 includes a lower well 62 and a finger cutout 64 leading into the indentation 58. The finger cutout 64 aids a user in removing the mood light 60 from the indentation 58.

The mood light 60 includes a lens 66 mounted on a front side, and a housing 68 shaped much like a hockey puck. In an embodiment, pressing on the lens 66 turns on the mood light 60. If desired, a different switch or button may be provided for turning on or otherwise controlling operation of the mood light 60.

As can be seen in FIG. 4, the mood light 60 includes a pocket 70 at one back edge. The pocket 70 includes a rail 72 extending across the pocket. Positioned below the pocket are two clip holes 74, 76.

In accordance with an embodiment, the pocket 70 and the rail 72 are arranged so that a lanyard 80 may be attached to the mood light 60, thus permitting the mood light to be hung around the neck of a user. Specifically, the lanyard 80 includes a clip 82 that may be inserted into the pocket and attached to the rail 72.

In an embodiment, the mood light 60 includes a belt clip, such as the belt clip 84 in FIG. 4. This belt clip 84 may be permanently attached to the back of the mood light 60, or may be removably attached, such as by protrusions (not shown) that attach to the clip holes 74, 76 on the backside of the mood light 60. The belt clip 84 permits a user to wear the mood light 60 clipped to an article of clothing, such as a pocket or a belt.

In accordance with an embodiment, when not in use, the lanyard 80 and/or the belt clip 84 may be stored in the well 62 below the mood light 60. The mood light 60 is friction fit into place with an undercut that has a spring-loaded release to fully secure the mood light into the indentation 58, and thus items in the well 62 are trapped below the mood light 60 and held in position. In accordance with alternate embodiments, different attachment mechanisms may be provided for the mood light 60 and/or the mood light 60 may not include attachment mechanisms such as the belt clip 84 and the lanyard 80. However, by making the mood light 60 removable from the lantern 20, a user may use the mood light separately from the lantern.

FIG. 6 shows a circuit 90 that may be used for the mood light 60 in accordance with an embodiment. In the embodiment shown, the mood light 60 includes red, green, and blue lamps 92, 94, 96, all mounted behind the lens 66. These lamps 92, 94, 96, may be, for example, separate LED's, or other suitable lamps, such as incandescent or fluorescent lamps. In addition, in accordance with an embodiment, a single LED having multicolor functions may be used to provide the functions of the three lamps 92, 94, 96. Also, although three lamps are shown in the embodiment in the drawings, the mood light 60 may utilize two lamps or more than three lamps.

The circuit 90 also includes power, in the form of a battery 98, and a switch 100. As set forth above, this switch 100 may be provided by pressing on the lens 66 or in another suitable manner.

In accordance with an embodiment, the circuit 90 includes a microcontroller 102 for controlling the amount of current provided to each of the lamps 92, 94, 96. In an embodiment, the current may be regulated so that several different functions are provided for the mood light 60. These functions may be provided in a particular order so as to have a mood effect. As examples, each of the individual lamps 92, 94, 96 may be lit separately or together with one of the other lamps. In addition, all the lights may be turned off or on at particular intervals. Also, a spectrum of the colors could be shown. In an embodiment, the current is regulated so that one of the lamps 92, 94, 96 is lit as another one is starting to dim, and the lamps are cycled in this manner to provide a mood effect. A person of ordinary skill could alter the lighting patterns in accordance with a desired effect.

The microcontroller 102 may be a standard control (i.e., a device or mechanism used to regulate or guide the operation of a machine, apparatus, or system), a microcomputer, or any other device that can execute computer executable instructions, such as program modules. Generally, program modules include routines, programs, objects, components, data structures and the like that perform particular tasks or implement particular abstract data types. A programmer of ordinary skill in the art can program or configure the microcontroller 102 to perform the functions described herein.

In an alternate embodiment, the mood light 60 may be mounted in or on a different location on the Lantern 20. As an example, the mood light 60 may be mounted on the base 22, or on a different position on the cap 28. Alternatively, a position at or in the globe 24 may be provided for the mood light 60. However, by providing the mood light 60 at the top of the cap 28, the mood light is visible when the lantern 20 is in use. Thus, in an embodiment, the mood light 60 may operate simultaneously with the lamp 32.

If desired, in accordance with an alternate embodiment, the mood light 60 may operate utilizing the same batteries or power source as the lamp 32. In such an embodiment, the mood light 60 may be permanently attached to the lantern 20, or may include contacts that engage and provide power for the mood light 60 when it is attached to the lantern 20.

FIG. 7 shows a bottom 150 of the lantern 20 providing storage for a remote control 152 in accordance with an embodiment. The remote control 152 may be utilized in a manner known in the art to control the operations of the lantern 20, including turning on and off the lamp 32 and/or dimming the lamp.

In accordance with an embodiment, a storage recess 154 is provided at the bottom 150 for receiving and storing the remote control 152. The storage recess 154 is sized to receive the remote control 152 so that the remote control does not contact the surface on which the lantern 20 is resting when the lantern is placed on the bottom 150. The storage recess 154 may include a clip 156 or other structure for holding the remote control in position. Alternatively, the remote control 152 may friction fit into place in the storage recess.

The storage recess 154 does not necessarily have to be contoured to fit the remote control 152. For example, in an embodiment, a rim may be provided around the bottom edge of the lantern, defining a large storage recess encompassing most of the bottom 150. A clip or other structure may be provided in the large recess for maintaining the remote control.

Mounting the remote control 152 to the lantern 20 provides convenient storage of the remote control, reducing the possibility of misplacing the remote control. While shown as being mounted in the bottom of the lantern 20, the remote control may be stored in other locations. However, by storing the remote control 152 under the bottom 150, the remote control and/or the recess 154 are not visible during normal operation of the lantern 20.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term, “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A lantern comprising:
a base;
a globe mounted above the base;
a cap mounted over the globe;
a lamp mounted in the globe;
a dimmer swatch for the lamp; and
a rotating collar mounted on the lantern for actuating the dimmer switch.

2. The lantern of claim 1, wherein the rotating collar is positioned just below the globe.

3. The lantern of claim 2, wherein the rotating collar is positioned at the top of the base.

4. The lantern of claim 1, further comprising a protrusion on the rotating collar, the protrusion being configured and arranged to aid a user in rotating the rotating collar.

5. The lantern of claim 1, wherein rotating the rotating collar both turns on and provides a dimming function for the lamp.

6. The lantern of claim 1, further comprising an on/off switch that is separate from the rotating collar.

7. The lantern of claim 1, wherein the lantern comprises indicia to show a current function provided by a position of the rotating collar.

8. A lantern, comprising:
a base;
a globe mounted above the base;
a cap mounted over the globe;
a lamp mounted in the globe; and
a mood light mounted to the lantern.

9. The lantern of claim 8, further comprising an indentation for receiving the mood light.

10. The lantern of claim 9, wherein the mood light is removably received in the indentation.

11. The lantern of claim 10, wherein the indentation includes a well arranged behind mood light when the mood light is received in the indentation.

12. The lantern of claim 10, wherein the indentation includes at least one finger cutout for aiding in removal of the mood light.

13. The lantern of claim 10, wherein the mood light includes an attachment structure for attachment to a lanyard.

14. The lantern of claim 10, further comprising a belt clip for attaching to the mood light.

15. The lantern of claim 10, wherein the mood light is friction fit into the indentation.

16. The lantern of claim 10, wherein the indentation comprises an undercut with a spring-loaded release.

17. The lantern of claim 8, wherein the mood light comprises a housing and a lens, and wherein pressing on the lens turns on the mood light.

18. The lantern of claim 8, wherein the mood light comprises a housing and a lens, and wherein the mood light comprises red, green, and blue lamps mounted behind the lens.

19. The lantern of claim 18, wherein the mood light comprises a control for cycling the red, green, and blue lamps to provide a mood effect.

20. A lantern, comprising:
a base;
a globe mounted above the base;
a cap mounted over the globe;
a lamp mounted in the globe;
a control system for controlling operation of the lamp; and
a remote control for actuating the control system, the remote control being removably mountable to the lantern.

21. The lantern of claim 20, wherein the remote control is removably mountable to an underside of the lantern.

22. The lantern of claim 20, further comprising a storage recess on the lantern for removably receiving and storing the remote control.

23. The lantern of claim 22, wherein the storage recess is positioned on a bottom side of the lantern.

24. The lantern of claim 23, wherein the storage recess is sized to receive the remote control so that the remote control does not contact a surface on which the lantern is resting when the lantern is placed on the bottom.

25. The lantern of claim 22, further comprising a structure for holding the remote control in position in the storage recess.
